(19) United States
(12) Patent Application Publication
(10) Pub. No.: US 2006/0117534 A1
(43) Pub. Date: Jun. 8, 2006

(54) Open hose clamp with plastically deformable ear

(76) Inventor: Paul M. Craig JR., Silver Spring, MD (US)

Correspondence Address: Paul M. Craig, Jr., 207 Quaint Acres Drive, Silver Spring, MD, 20904, US

(21) Appl. No.: 11/328,679

(22) Filed: Jan. 11, 2006

Related U.S. Application Data
(62) Division of application No. 10/392,952, filed on Mar. 21, 2003.

(51) Int. Cl. F16L 33/025

(52) U.S. Cl. 24/20 CW

(57) ABSTRACT

An open-type clamp in which the clamping band end portions are intended to form overlapping inner and outer band portions that are connected by a connection, in which the plastically deformable tightening device for tightening the clamping band about an object to be fastened requires an initial plastic deformation for proper operation and in which a guide arrangement is provided in the end area of the inner clamping band portion to guide the relative movement between overlapping band portions during plastic deformation of the ear, whereby the connection includes a lost-motion arrangement permitting initial plastic deformation of the tightening device substantially without change in radial dimension to avoid the installation of an undersized clamp. According to the method of this invention the amount of lost motion is thereby correlated to the amount of initial plastic deformation necessary to assure proper operation of the tightening device.

This application is a divisional application of my Utility patent application Ser. No. 10/392,952, filed Mar. 21, 2003, entitled “Open Hose Clamp With Plastically Deformable Ear,” which application claimed and I claim also the benefit of U.S. Provisional Application 60/439,799, filed on Jan. 14, 2003.

### FIELD OF THE INVENTION

This invention relates to an open-type hose clamp provided with a plastically deformable ear of the “Oetiker” type as tightening device, and more particularly to a hose clamp of this type which minimizes the danger of utilizing an undersized clamp in a given application.

### BACKGROUND OF THE INVENTION

Tightening devices in the form of plastically deformable ears of the “Oetiker” type have been known for more than a half a century (U.S. Pat. No. 2,614,304). These types of plastically deformable ears as tightening devices have proved immensely successful in very large numbers of clamps involving both the endless as well as open-type clamps. For example, so-called stepless clamps utilizing this type of tightening device as exemplified by U.S. Pat. No. 4,299,012 have been sold in the hundreds of millions. FIG. 1 of this application, which is a typical stepless open hose clamp with a plastically deformable ear of the so-called “Oetiker” type, is only one of the numerous types of clamps using such tightening devices. FIG. 1 herein, which corresponds to FIG. 19 of the U.S. Pat. No. 4,299,012, includes a male member in the form of a narrow tongue-like extension (61) at the end of the full width inner band portion (11b) adapted to engage through an opening (62) forming a female member that commences in the outer band portion (11a) at the beginning of a step-like portion (67) having a height substantially corresponding to the thickness of the clamping band. These parts so far described of FIG. 1 provide a stepless transition of the end of the inner clamping band portion to the remaining clamping band. In addition to the plastically deformable ear of the “Oetiker” type (13) that includes two outwardly extending leg portions (14 and 15) interconnected by a bridging portion (16) provided with a reinforcing groove or depression (17), this type of prior art clamp also shows a mechanical connection consisting of a so-called guide or suspension hook (31) and of two cold-deformed, deep-drawn support hooks (32) adapted to engage in apertures (35) in the outer band portion (11a). The channel (63) adjoining the opening in the step-like portion (67) is formed by cuts whereby the cover is pressed out relative to the remaining lateral band portions (11′) to form a window-like opening. However, the cover (63) can also be omitted by simply cutting off the material forming the opening and the channel so that the tongue-like extension (61) is then freely exposed to the outside as disclosed in the U.S. Pat. No. 4,315,348.

### SUMMARY OF THE INVENTION

Normally clamps of a given type come in different, step-like sizes of nominal diametric dimension with the diametric dimensions between the steps being preferably bridged by a tolerance range of a given clamp size involving a range of diametric dimensions from dₘₐₓ to dₘᵢₙ. As will be explained in greater detail hereinafter, tightening devices involving plastically deformable ears of the “Oetiker” type require a minimum plastic deformation, to be referred to hereinafter as “initial plastic deformation” to function properly and provide the necessary clamping forces. As will also be explained in detail hereinafter, with clamps of the prior art this may lead to the possibility of inadequate holding of the clamp if the ear cannot be deformed to attain the “initial plastic deformation” as a result of a clamp size chosen for a hose having a diametric dimension greater than the diametric dimension corresponding to the “initial plastic deformation.”

Accordingly, it a primary object of the present invention to provide an open-type hose clamp with a plastically deformable ear of the “Oetiker” type which minimizes the danger of inadequate holding as a result of a clamp size which is too small for a given diameter of the hose.

A further object of the present invention resides in an open-type clamp structure with a plastically deformable ear of the “Oetiker” type which prevents the installation of an undersized clamp over the hose even before plastic deformation of the ear is attempted.

A still further object of this invention resides in an open-type clamp of the type described above in which substantially no change in diametric dimension occurs during “initial plastic deformation” of the ear. The term “initial plastic deformation” is used herein to describe the amount of plastic deformation necessary to assure proper operation of the tightening device to produce the necessary clamping forces.

The aforementioned problems are solved according to this invention by providing a guide arrangement in the end area of the inner clamping band portion and a mechanical connection of the overlapping band portions in the end area of the outer clamping band portion which includes a lost-motion arrangement. The guide arrangement in the end area of the inner clamping band portion and the lost-motion arrangement in the end area of the outer clamping band portion are thereby located at such a distance from one another in the circumferential direction that the guide arrangement and/or the mechanical connection cannot be engaged if the diametric dimension of the hose is greater than the diametric dimension of the given clamp that corresponds to the diametric dimension when “initial plastic deformation” has been reached. In other words, if the outer diametric dimension of the hose is greater than do which is the diametric dimension of the given clamp after “initial plastic deformation” has been reached, the guide arrangement and/or the mechanical connection with the lost-motion arrangement cannot be engaged. This means that the actual outer diametric dimension of the hose dₕ must be smaller than dₒ in order that the clamp can even be installed over the hose.

### BRIEF DESCRIPTION OF THE DRAWINGS

These and further objects, features and advantages of the present invention will become more apparent from the following description when taken in conjunction with the accompanying drawing, which shows, for purposes of illustration only, several embodiments in accordance with the present invention, and wherein:

FIG. 1 is a somewhat schematic perspective view of a prior art hose clamp as disclosed in U.S. Pat. No. 4,299,012;

FIG. 2 is a somewhat schematic, partial top plan view of one embodiment in accordance with the present invention with the mechanical connection and the guide arrangement engaged, the clamp being flattened out for easier understanding;

FIG. 3 is a somewhat schematic partial side elevational view of the clamp shown in FIG. 2;

FIG. 4 is a somewhat schematic partial top plan view of a part of the inner clamping band portion of the clamp illustrated in FIGS. 2 and 3;

FIG. 5 is an exploded, somewhat schematic cross-sectional view, taken along line 5-5 of FIG. 2, and explaining the present invention;

FIG. 6 is a partial side elevational view of a modified embodiment of a hook for use in the mechanical connection with a lost-motion arrangement according to this invention;

FIG. 7 is a partial side elevational view of a modified embodiment of a hook for use in the area of the end of the inner clamping band portion of the guide arrangement in accordance with this invention;

FIG. 8 is a partial side elevational view of a still further modified embodiment of a hook for use in the mechanical connection with a lost-motion arrangement according to this invention;

FIG. 9 is a partial side elevational view of still another modified embodiment of a hook for use in the mechanical connection with a lost-motion arrangement according to this invention;

FIGS. 10 and 11 are somewhat schematic top plan views of the end area of the outer clamping band portion explaining the operation of the present invention;

FIG. 12 is a somewhat schematic partial top plan view of a modified embodiment of the end area of the outer clamping band portion provided with a reinforcing arrangement according to this invention;

FIG. 13 is a cross-sectional view, taken along line 13-13 of FIG. 12;

FIG. 14 is a somewhat schematic, partial top plan view of the end area of the outer clamping band portion illustrating a modified embodiment of a mechanical connection that includes, in addition to the lost-motion arrangement, a cold-deformed, deep-drawn support hook;

FIG. 15 is a partial, somewhat schematic top plan view of the outer band portion in the area of a modified embodiment of a guide arrangement in accordance with this invention;

FIG. 16 is a partial, somewhat schematic top plan view of the inner clamping band end area for the guide arrangement of FIG. 15;

FIG. 17 is a cross-sectional view, taken along line 17-17 of FIG. 16; and

FIG. 18 is a somewhat schematic partial cross-sectional view through a modified embodiment of a clamp in accordance with the present invention utilizing support hooks of the type shown in FIG. 9 in the mechanical connection thereof.

### DETAILED DESCRIPTION OF THE DRAWINGS

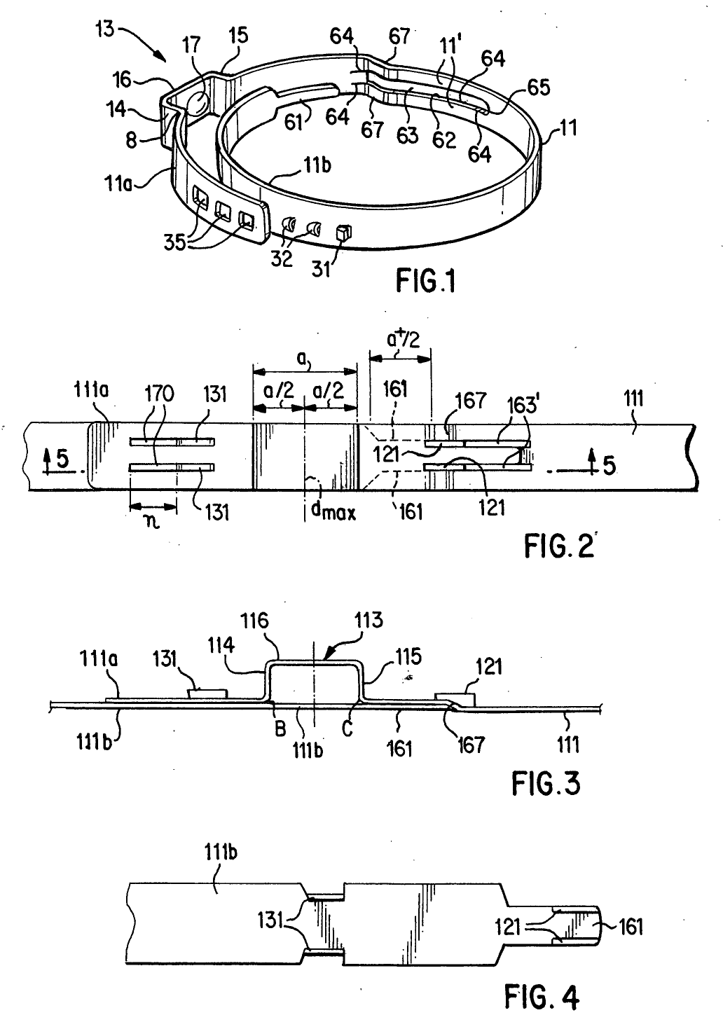

Referring now to the drawing wherein corresponding reference numerals are used throughout the various views to designate corresponding parts, a few words are believed appropriate to explain the underlying theoretical principles of the present invention. Though the “initial plastic deformation” of a typical “Oetiker”-type ear depends on such variable factors as thickness and material used for the clamping band, e.g., stainless steel or galvanized steel, the size of the plastically deformable ear, the size of the clamp, etc., a plastic deformation of about 40% to about 60% is the general rule to reach the point of “initial plastic deformation.” For purposes of explanation, it will be assumed that the “initial plastic deformation” of the ear is 50%, i.e., is a/2 in FIG. 2 where the maximum plastic deformation of the ear is a, reached when the points B and C (FIG. 3) come into contact with one another. The compressibility of the hose as also any limited spring-back after plastic deformation is ignored because it is inconsequential to the explanation of the present invention.

The circumferential length of a clamp is given by the equation of
l=πd,
where l is the circumferential length of the clamping surfaces of the clamp and d is the diametric dimension of the clamp.

Assuming the “initial plastic deformation” in a clamp of the type illustrated in FIGS. 2 and 3 herein is a/2, it means in theory that the clamp decreases in diametric dimension during the “initial plastic deformation” by an amount

$$d = \frac{a / 2}{π}$$

As the maximum diametric dimension dₘₐₓ in the tolerance range of the clamp should be less than dₒ, where dₒ is the diametric dimension at the point when “initial plastic deformation” is reached, it is possible to engage the mechanical connection in a clamp of the type illustrated in FIG. 1 even when the actual outer dimension of the hose dₕ is greater than dₒ. This means that the point of “initial plastic deformation” can never be reached under those circumstances and the clamp may not provide the necessary clamping forces in a given application.

With pneumatic pincer-like tools as used, for example, on the assembly line, a constant tightening force is applied to the ear with every actuation. If an undersized clamp is used, there is the possibility that the mechanical connection in a clamp of the type shown in FIG. 1 herein will be destroyed by tearing of the opening(s) 35 and/or by destruction of the ear itself by the sharp edges of the jaws of the pincer-like tool, especially with thinner-type clamping band materials. Thus, a certain safeguard exists with presently available pneumatic pincer-like tightening tools, though even this safeguard is not 100%. However, this limited safeguard is further lessened in the aftermarket where usually manually operated pincer-like tools are used so that the force necessary for destruction of the mechanical connection and/or of the ear is never reached by the installer. Moreover, there is always the possibility in the aftermarket that the required size of the clamp for a given application is not available to the person repairing the hose.

This invention solves the problem by precluding the engagement of the mechanical connection and/or of the guide arrangement if the outer diametric dimension dₕ of the hose or hose and nipple combination is greater than the diametric dimension dₒ corresponding to “initial plastic deformation.” This is achieved according to this invention by a lost-motion arrangement in the mechanical connection and a guide arrangement in the end area of the inner clamping band portion so that the ear can be plastically deformed without changing the diametric dimension of the clamp up to the point where dₒ would be reached. In other words, the maximum diametric dimension of the hose at which the mechanical connection and the guide arrangement can still be engaged corresponds to the diametric dimension of the clamp at or near dₒ.

Viewed differently, the initial circumferential length lᵢ of the clamping surfaces of the embodiment of FIG. 1 is given by the equation
lᵢ=π×dᵢ

In the given example, the diametric dimension dₒ in the example of FIG. 1 would be equal to

$${d}_{o} = \frac{{1}_{i} - a / 2}{}$$

In the clamp of FIG. 1, the mechanical connection can always be engaged up to the point corresponding to the initial length lᵢ of the clamp, i.e., to the initial diametric dimension

$${d}_{1} = \frac{{1}_{i} .}{}$$

According to this invention, the initial circumferential length l′ᵢ is made equal to or close to lₒ, which not only provides a saving in clamping band material, as explained in my aforementioned Provisional Application, but always permits nonetheless plastic deformation of the ear corresponding to the “initial plastic deformation” as a result of the presence of the lost-motion arrangement in the connection. It also means that if the outer diameter dₕ of the hose is greater than

$$\frac{{1}_{i}^{′} ,}{}$$

the mechanical connection and/or the guide arrangement can no longer be engaged.

This is achieved in a particularly simple and reliable manner by a clamp illustrated in FIGS. 2 through 5 which represents one embodiment of this invention.

In FIGS. 2 through 5, the clamp is provided with a plastically deformable ear of the “Oetiker” type generally designated by reference numeral 113 which includes outwardly extending leg portions 114 and 115 interconnected by a bridging portion 116 which is preferably provided with a reinforcing arrangement (not shown) of any conventional type. The inner ends of the leg portions 114 and 115 pass over into the outer clamping band portions 111a at points B and C. The minimum diametric dimension dₘᵢₙ of the tolerance range is reached when points B and C contact with one another. In the embodiment illustrated in these figures, the maximum diametric dimension dₘₐₓ should be at most at the point dₒ of the initial plastic deformation and preferably is somewhat smaller whereby dₒ in the clamp according to this invention already corresponds substantially to the maximum diametric dimension of the clamp at which the mechanical connection and the guide arrangement can still be engaged. To achieve a stepless transition at the inner end of the overlapped clamping band end portion 111b, the outer clamping band portion 111a is provided with a step-like portion 167 of a height substantially corresponding to the thickness of the clamping band material which passes over into the remainder of the clamping band 111.

As explained in my aforementioned Provisional Application, it is desirable that any gap underneath the ear 113 be bridged by the full band width of the inner clamping band portion 111b and that the tongue-like part 161 at the end of the inner clamping band portion therefore commence only to the right of leg portion 115 as viewed in FIGS. 2 and 3. As further explained in my aforementioned Provisional Application, a preferred guide arrangement thereby includes two bent-up tab-like members 121 on both sides of the tongue-like extension 161 obtained by appropriate cuts in the clamping band when the tongue-like extension is formed during manufacture of the blank. The tab-like members 121 engage in guide slots 163′ whereby the tongue-like extension 161 can pass through the window-like opening formed in the step-like portion 167.

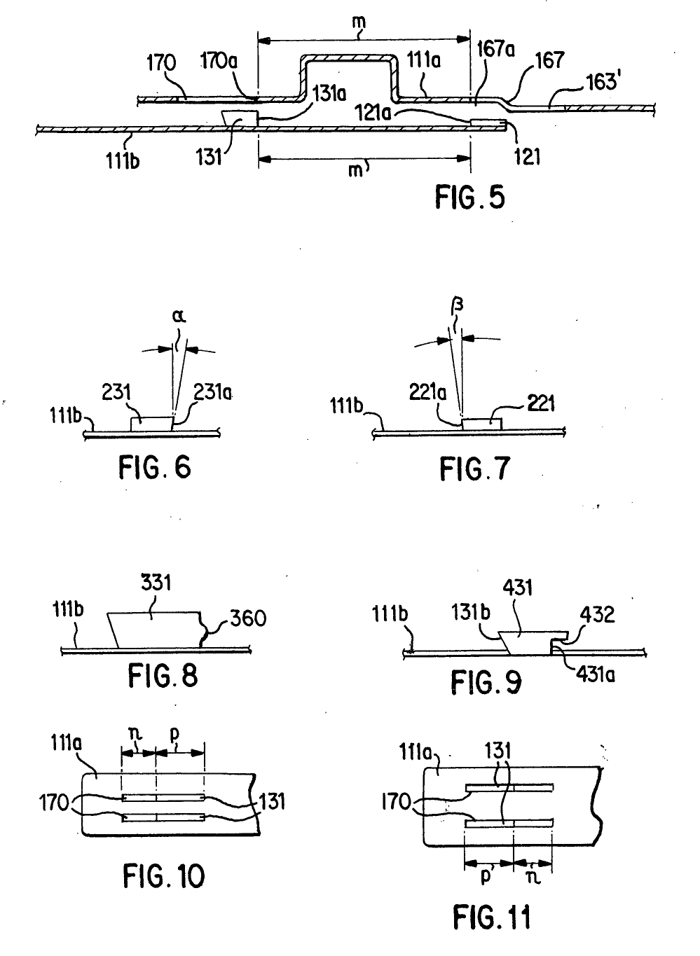

The mechanical connection includes in a preferred embodiment two tab-like members 131 bent-up on both sides of the inner band portion 111b which engage in guide slots 170 provided in the end area of the outer clamping band portion. The distance m (FIG. 5) indicates the maximum distance between the guide arrangement 121, 163′ and the mechanical connection 131, 170 at which the guide arrangement and/or the mechanical connection can still be engaged. If the diametric dimension of the hose is greater than dₒ, it causes the inner clamping band portion to move to the left as viewed in FIG. 5 and/or the outer clamping band portion 111a to move to the right as viewed in FIG. 5, in which case both of the two tab-like members 131 and 121 can no longer engage in their respective guide slots 170 and 163′. The designer of the clamp thus has the possibility of determining at which circumferential length of the hose the tab-like members 131 and/or 121 can no longer engage in their respective guide slots. This, in turn, will prevent the selection of a clamp size which is inadequate for a given diametric dimension of the hose.

As to the rest, the preferred dimensions for the distances a/2⁺, b, n and p shown in FIG. 2, reference is made to my aforementioned Provisional Application which is expected to be published in due course.

A pre-deformation of the ear to the point of “initial plastic deformation” is now assured under all circumstances as long as dₕ<dₒ. To achieve the same assurance, it would require complicated additional steps in the manufacture of the prior art clamps, such as pre-deformation of the ear during or after the blank manufacturing steps. Moreover, such pre-deformation of the ear would not provide the same degree of safeguard because the pre-deformed ear could be spread open by hand to accommodate an oversized hose. In contrast, the ear in the clamp according to this invention is in its original non-deformed condition which makes it much more difficult to further open up the leg portions 114 and 115. At the same time, the lost-motion arrangement of this invention allows plastic deformation of the ear even after the clamp is actually installed, which means that with hoses of dₘₐₓ, the plastic deformation of the ear still takes place in a continuous motion.

As mentioned above, the lost-motion arrangement in the mechanical connection should allow the “initial plastic deformation” of the ear substantially without change in diametric dimension. The maximum dimension dₘₐₓ of the tolerance range should be no more than the diametric dimension dₒ corresponding to “initial plastic deformation.” As a precautionary measure, the dimension dₘₐₓ at which the clamp can be installed, should be chosen slightly smaller than do corresponding to the “initial plastic deformation.” Moreover, again as a precautionary measure, it may be desirable to make the operative distance of the lost-motion arrangement somewhat less than a/2 in the given example. In all cases, the actual values may be adapted to optimum conditions that can be readily empirically determined.

### Operation

It is assumed in this explanation that the tightening tool closes the ear symmetrically, i.e., points B and C move toward one another equal distances a/4. As point C moves toward the left in FIG. 3, the clamping band 111a, 111 on the right side of ear 113 will partake in this movement that then becomes a counterclockwise movement for the inner band portion 111b. Therefore there will be no relative movement between the outer clamping band portion 111a and the tab-like members 121 in their guide slots 163′ though the tab-like support members 131 move at the same time a distance a/4 in their guide slots 170. The initial circumferential length lᵢ of the clamp remains the same. By the same token, as point B moves toward the right in FIG. 3 by a distance a/4, the guide slots 170 which in the assumed example have a length equal to a/2 will partake in this movement of point B so that the tab-like support members 131 will reach the edges of guide slots 170 nearer the free end of the outer clamping band portion 111a. Because of the lost-motion arrangement, this initial a/4 movement of point B also does not change the circumferential length of the internal clamping surfaces of the clamp. However, when the tab-like support members 131 abut against the edge of the guide slots 170 nearer the free end of the outer clamping band portion 111a, any further contraction of ear 113 will then cause a reduction in the circumferential length of the clamp and therewith a reduction in the diametric dimension of the clamp. It is thus possible to permit a plastic deformation of the ear without change in the diametric dimension of the ear. In other words, the initial length lᵢ of the clamp can now be chosen to be at or near the length lₒ while assuring at all times a plastic deformation of the ear to the point of “initial plastic deformation” provided dₕ is no larger than dₒ, i.e., no larger than dᵢ.

According to a modification of this invention, the tab-like members 231 and/or 261 may be provided with trailing edges 231a and 261a (FIGS. 6 and 7) that form an angle slightly different from a right angle with respect to the outer surface of the corresponding clamping band portion as shown in FIGS. 2-5. The angles α and β can be chosen at will depending, for example, on the size of the clamp. As a general rule, the angles α and β, which may be the same or different from one another, may be in the range of 4° to 15° (FIGS. 6 and 7). This permits as a safety feature to assure that dₘₐₓ is smaller than dₒ. In the alternative, in lieu of an angle, the trailing edges may be substantially at right angle to the surface of the respective clamping band portion but may be provided with a protuberance 360 (FIG. 8) shown only for the tab-like member 331. Again, only one pair of the tab-like members may be provided with such protuberance or both pairs of the tab-like members may be provided with such protuberances.

FIG. 9 illustrates a further modified embodiment of a tab-like member 431 which is provided with an undercut 432. By first installing the tab-like members 431 in their respective guide slots, the maximum dimension m can be accurately determined by the location of the surface 431a inside of the undercut (FIG. 18).

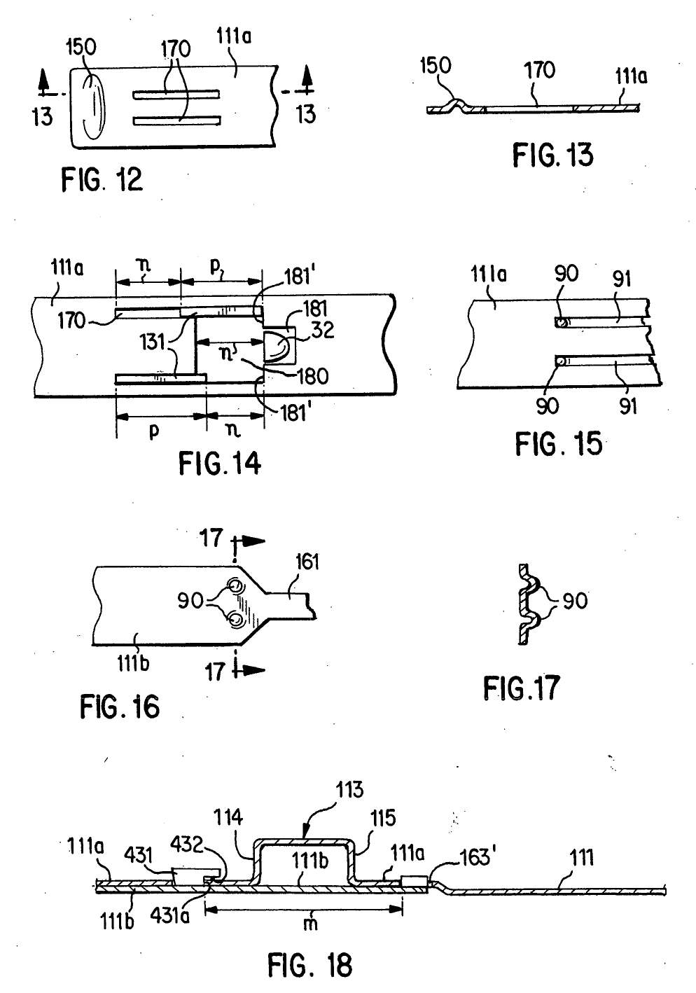

The tab-like members 131, 231, 331 and 431 are capable of absorbing considerable forces in the longitudinal direction of the clamping band and thus are capable of acting as support hooks. To protect against tearing out of the guide slots 170, a reinforcement 150 (FIGS. 12 and 13) may be provided near the end of the outer clamping band portion 111a.

FIGS. 10 and 11 illustrate typical dimensions for the length of the guide slots 170 in relation to the length p of the tab-like members 131′ in their respective positions of lᵢ and lₒ.

FIG. 14 illustrates a space-saving arrangement for a mechanical connection that includes, in addition to the tab-like support members 131, a deep-drawn support hook 32 of the type described in the aforementioned U.S. Pat. No. 4,299,012. In this embodiment, the outer clamping band portion 111a is provided with a cut-out 180 that removes the part of the outer clamping band portion between the guide slots 170 and extending the cut-out to form a narrower pocket 181. Pocket 181 has a width which is less than the spacing between tab-like members 131 so that an abutment 181′ is formed against which rests a tab-like member 131 in the position in which the guide arrangement and mechanical connection can be engaged. The distances n and p are shown in the upper half of FIG. 14 for the condition in which the mechanical connection is engaged without plastic deformation of the ear while the lower half indicates the position after “initial plastic deformation.” To assure proper operation, it is preferable if the distance p is such that the tab-like members already engage with their leading edges in the guide slots (upper half of FIG. 14).

Though the guide arrangement utilizing two tab-like members 121 in the end area of the extension 161 is preferable because of superior guide function, the guide arrangement may also consist of only a single tab-like member as shown, for example, in U.S. Pat. No. 5,305,499 or two tab-like members formed out of the full band width of the inner band portion as shown, for example, in U.S. Pat. Nos. 4,712,278; 5,339,496 and 5,544,392. However, the location of the tab-like member(s) also impacts on the length of the blank.

The guide function for the overlapping band portions may also be achieved by substituting a deep-drawn, outwardly extending pin-like embossment generally designated by reference numeral 90 (FIGS. 15 and 16) for each tab-like member 121. The pin-like embossments 90 may be of any shape as shown in U.S. Pat. No. 4,312,101, but is preferably of pin-like shape and engages in corresponding guide slots 91. Though a single such embossment located in the center area of the inner band portion or of the tongue-like extension is possible, two such pin-like embossments are preferable because they continue to provide a guide function even as they find themselves in the area of the cut-out window for the tongue-like extension provided the laterally outer surfaces of the guide slots 91 coincide with the lateral surfaces of the cutout window. On the other hand, a single such pin-like embossment offers the advantage that it may be located in the tongue-like extension, i.e., further toward the end area of the inner band portion, in which case one must rely on the guide function of the tongue-like extension within the cutout window.

Furthermore, though the use of tab-like members 131 is preferable for reasons of band length economy of the blank, the mechanical connection may also be of any other known type, for example, of the type shown in U.S. Pat. No. 4,315,348 or 5,305,499 or of the type shown in FIG. 1 herein in which case the openings 35 have to be correspondingly lengthened to provide a lost-motion of adequate movement.

While I have shown and described several embodiments in accordance with the present invention, it is understood that the same is not limited thereto but is susceptible of numerous changes and modifications as known to those skilled in the art. For example, the present invention is also applicable to clamps with modified “Oetiker” ears as shown in my prior U.S. Pat. No. 6,247,206, it only being necessary to determine for each type of ear the amount of contraction necessary to attain “initial plastic deformation.” I therefore do not wish to be limited to the details shown and described herein but intend to cover all such changes and modifications as are encompassed by the scope of the appended claims.

What is claimed is:

1. A method of manufacturing an open-type clamp which includes a clamping band having clamping band end portions intended to form overlapping inner and outer band portions in the installed condition, a connection with a lost-motion arrangement operable to connect overlapping band portions, a plastically deformable tightening device requiring an initial plastic deformation for proper functioning, and a guide arrangement in the end area of the inner band portion, comprising the steps of determining the amount of plastic deformation necessary to reach the point of the initial plastic deformation, and correlating the amount of lost motion to said amount of plastic deformation.

2. A method according to claim 1, further comprising the step of cutting a blank of clamping band material of such size that the maximum diametric dimension of the clamp is at most equal to the size when initial plastic deformation is reached.

3. In a clamp which includes a clamping band having clamping band end portions intended to form overlapping inner and outer band portions in the installed condition, a connection with a lost-motion arrangement operable to connect overlapping band portions, a plastically deformable tightening device requiring an initial plastic deformation for proper functioning, the method comprising the steps of determining the amount of plastic deformation necessary to reach said initial plastic deformation of the tightening device sufficient for proper functioning thereof, and correlating said deformation to the amount of lost motion in said connection.

4. A method of assuring sufficient plastic deformation of a plastically deformable tightening device in a clamp which includes a clamping band having clamping band end portions intended to form overlapping inner and outer band portions in the installed condition, a connection with a lost-motion arrangement operable to connect overlapping band portions, said plastically deformable tightening device requiring an initial plastic deformation for proper functioning thereof, comprising the steps of determining the amount of deformation necessary to reach the point of said initial plastic deformation, and correlating said initial plastic deformation to the amount of lost motion in said lost-motion connection.

5. A method according to claim 4, wherein said lost motion connection permits plastic deformation of said tightening device without reduction of the diametric dimension of an installed clamp.

6. In a clamp which includes a clamping band having clamping band end portions intended to form overlapping inner and outer band portions in the installed condition, a lost-motion connecting means for connecting overlapping band portions in such a manner that substantially no reduction in the diametric dimension occurs in the installed condition of the clamp during initial plastic deformation of its tightening device, and said plastically deformable tightening device requiring a predetermined initial plastic deformation for proper functioning thereof, comprising the steps of determining the amount of said predetermined initial plastic deformation and correlating the same to the amount of lost motion in said connecting means.

7. A method according to claim 6, wherein said lost-motion connecting means includes a slot in one of said band portion and a member in the other of said band portion of smaller dimension than said slot and extending through said slot, and wherein the correlating step correlates the length of said slot to said initial plastic deformation.
